(19) United States
(12) Patent Application Publication
(10) Pub. No.: US 2004/0103025 A1
(43) Pub. Date: May 27, 2004

(54) Substitute opportunity sales method and system

(75) Inventors: David Ulf, Bethesda, MD (US); Jay Richmond, Bethesda, MD (US)

Correspondence Address: YOUNG & THOMPSON, 745 SOUTH 23RD STREET 2ND FLOOR, ARLINGTON, VA, 22202

(73) Assignee: WTT, INC., DOING BUSINESS AS RADIUS, BETHESDA, MD

(21) Appl. No.: 10/304,757

(22) Filed: Nov. 27, 2002

(51) Int. Cl. G06F 17/60

(52) U.S. Cl. 705/14; 705/5

(57) ABSTRACT

A substitute opportunity sales method and system, targeted at moving a purchaser off their original purchase choice and onto a substitute purchase, may be embodied in a reservations system and include offering the purchaser an at least equivalent substitute reservation after the purchaser has tendered a reservation purchase for an original reservation.

### BACKGROUND OF THE INVENTION

The invention is directed to a method and system for maximizing opportunity sales by moving a purchaser off an original purchase choice after the purchaser has actually purchased or committed to purchasing an item, e.g., life insurance, annuities, stocks, mortgages, consumer products, travel reservations, hotel rental reservations, and automobile rental reservations, by offering the purchaser a substitute purchase of an at least equivalent substitute item.

### DESCRIPTION OF THE RELATED ART

There are many prior art techniques for influencing a consumer's purchasing choices. Techniques have been developed for increasing repeat sales of a particular product, assuring repeat sales from existing customers, influencing existing customers to purchase an alternative manufacturer's product (e.g., one having a higher margin), and attracting new customers away from competitors.

To maintain market share, market participants in a given industry will take measures to keep existing customers satisfied. For example, automobile manufacturers offer existing customers special rebates for trading their current automobile for a new model, and many product or service providers survey clients to identify strengths and weaknesses in their delivery of products and services, e.g., post-service surveys conducted by automobile manufacturers, restaurants, and hotels.

To increase sales from existing customers, some grocery stores use check-out couponing. Check-out coupons are generated by a printer connected to the check-out register. As items are entered into the register for purchase, specific coupons are generated based upon the items actually purchased. These coupons are savings at that store on an up-coming shopping trip and hence encourage return shopping by the existing customer to that store.

Check-out couponing does not, however, target competitor's customers, i.e., customers of another store.

To increase market share, market participants may “purchase” or “buy” competitor's customers by offering incentives to cause the competitor's customer to switch providers, i.e., to the business offering the incentive.

An example of a switching incentive is the practice of a grocery store honoring any grocery store's coupons as being their own. However, this practice is not targeted to a particular competitor or consumer and further does not speak to the consumer's concern to receive at least equivalent quality at an ultimately at least equivalent cost since the goods being offered and prices being charged vary as between grocery stores.

### SUMMARY OF THE INVENTION

The present invention seeks to provide an improve method and system for influencing a consumer's purchasing decisions in a focused manner that overcomes some of the shortcomings of the prior art.

The invention is directed to consumers who have looked for a product meeting a criteria set and, have 1) not found that product, 2) found and committed to purchase the product, and 3) found and purchased the product but not yet consumed the product.

In one broad aspect, the present invention is directed to a method and system for maximizing opportunity sales by influencing a purchaser (an actor) to move off an original purchase choice by presenting the purchaser with a substitute purchase offer of an at least equivalent substitute item.

In one embodiment of the invention, the substitute purchase offer is made only after the purchaser has made a commitment to purchase an item, e.g., a travel agent has pressed a “purchase icon” for a specific hotel room reservation at a specific price. In another embodiment, the substitute purchase offer is made after the purchaser has made the purchase, but not yet consumed the purchase, e.g., having purchased an air plane-ticket but not yet consumed the ticket by taking the associated plane flight.

One object of the invention is to provide a method of maximizing opportunity sales by moving a purchaser off an original purchase choice at a first price and onto a substitute purchase, by offering to sell to the purchaser an equivalent item to the original purchase choice at a price at least as favorable as the first price, upon being notified of the purchaser has already tendered a purchase commitment for the original purchase choice (a first item at the first price).

The invention, in waiting, until after there has been an actual tender of purchase commitment, to find an equivalent item and presenting the equivalent item as a substitute purchase offer, allows for a focused targeting of customers and tailoring of the offers being made to “purchase” customers who are known to actually purchase certain products at certain prices.

Although prior art methods make alternative purchase offers to customers making product purchase inquiries, making the alternative purchase offer at the point of customer inquiry and prior to the actual customer commitment to purchase, does not allow a market participant to know with certainty what a customer would actually pay for a certain product having a certain characteristic set.

Another object of the invention is a method that includes determining if opportunity item, from a group of opportunity items, qualifies as the equivalent item by determining if any opportunity item comprises a characteristics set equivalent to a corresponding characteristics set for a first item that a purchaser has decided to purchase at a first price, and determining if a price of that opportunity item is at least as favorable as the first price. These aspects of the invention direct the substitute offer to an item that will be viewed as being as favorable, or more favorable, than the original purchase choice.

Still another object of the present invention is to decide that the characteristics set for an opportunity item is equivalent to the characteristics set for the first item when every item of characteristics set for the opportunity item is identical to those of first item.

A still further object of the present invention is to allow a purchaser or a purchaser's agent to make a purchase inquiry for a specific item at a first price and have thereafter alternative substitutes items be presented where the equivalent item comprises a characteristics set equivalent to a characteristics set for the specific item and a price at least as favorable as the first price. The method may provide that the equivalent item's characteristics set is judged equivalent to the specific item's characteristics set when each item of the equivalent item's characteristics set is at least as favorable as each those of the desired item.

One other object of the invention is to provide an improved reservations method and system where the purchase inquiry is a reservation inquiry made against an industry reservations database, and the equivalent item is found by an inquiry made against a different reservations database, where the two databases may or may not be co-located.

Embodiments of the invention include hotel room reservations, automobile rental reservations, and travel (e.g., land, sea, or air) reservations.

In additional to the invention involving various methods, the invention includes an overall system for maximizing opportunity sales by moving a purchaser off an original purchase choice and onto a substitute purchase. Such a system may include plural computer programs/scripts located on computers remote from one another.

Other embodiments of the invention include a computer program residing on a purchaser's computer where the computer program is adapted for sending the reservation inquiry to a first computer program (e.g., on an industry reservations database server), receiving from the first computer program an offering response to the reservation inquiry presenting a reservation offering for the specific item at the first price, sending a second computer program (e.g., on an opportunity database server) data from the offering response, and sending the second computer a reservation commitment sent responsive to the offering response.

These features allow a user's computer (an actor) to make an inquiry, receive a response, commit to the response, and notify an opportunity computer of the user's commitment to make the purchase. This embodiment also provides that the user's computer accepts from the opportunity computer a sale commitment offering to sell a found equivalent substitute item to the user.

Another embodiment of the invention comprises a computer program residing on an opportunity computer receiving notice that a purchaser has made a commitment to purchase an item, to select an opportunity substitute item, and to send to the purchase an offer to sell the opportunity substitute item, the opportunity substitute item being selected so as to entice the purchaser to move off the original purchase decision and to move onto the opportunity substitute purchase.

### BRIEF DESCRIPTION OF THE DRAWINGS

FIG. 1 is a flow chart of a method embodiment of the invention.

FIG. 2 is a flow chart of another method embodiment of the invention.

FIG. 3 is a flow chart of yet another method embodiment of the invention.

FIG. 4 is a flow chart of a still another method embodiment of the invention.

FIG. 5 is a flow chart of again another method embodiment of the invention.

FIG. 6 is a diagram of a system embodiment of the invention.

### DESCRIPTION OF THE PREFERRED EMBODIMENTS

Although the present invention includes embodiments directed to the purchase of life insurance, annuities, stocks, mortgages, consumer products, travel reservations, hotel rental reservations, and automobile rental reservations, an exemplary embodiment involving hotel rental reservations is presented below in discussing preferred embodiments. These embodiments are intended to be illustrative and non-limiting.

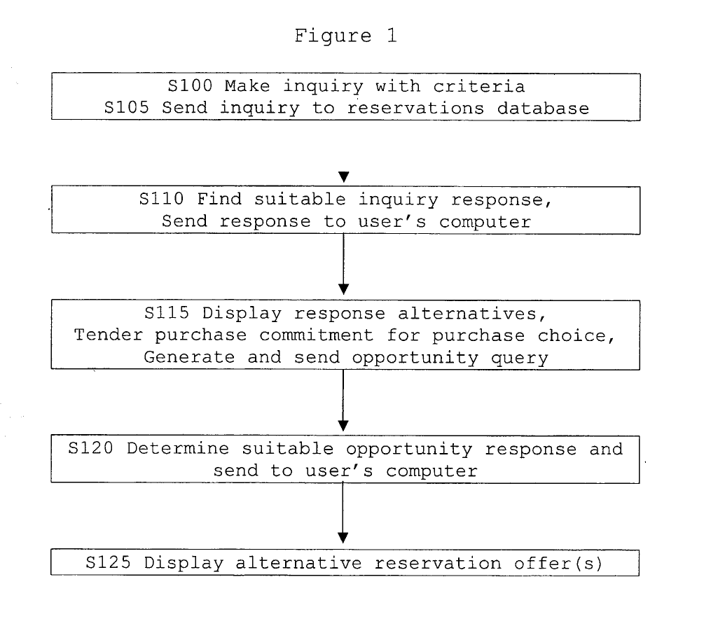

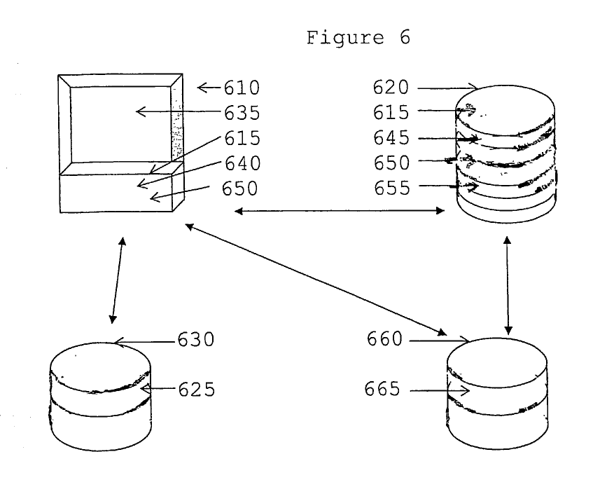

A method embodiment of the invention directed to a method for making hotel rental reservations is illustrated by FIG. 1, which method can be used by a purchaser directly making a reservation using, e.g., a computer connected to the Internet, by a reservations agent using, e.g., a computer connected to a dedicated network or to the Internet, and by other reservation providers. FIG. 6 is a system diagram.

The use of the term “computer” includes wired and wireless communication devices such as personal digital assistances (“PDAs”) and other communication devices and terminals. Further, the inventive method is not limited to use with computers.

With reference to FIG. 1, a user makes a reservation inquiry (step 100) using a user computer 610. The reservation inquiry involves providing selection/preference criteria for a desired hotel room reservation. The selection/preference criteria make up criteria for a characteristics set.

This action may or may not specify a particular hotel by name, and rather may be an inquiry as to all hotels having a characteristics set meeting provided criteria. These criteria may include, e.g., a hotel quality indicator (e.g., 4 stars or better), reservation dates, room type (e.g., no smoking, king-size bed), location (e.g., within 10 kilometers of London), and a nightly cost.

Certain of the user's selection/preference criteria may be saved for re-use and for automatically populating an inquiry screen during subsequent inquires. Examples of saved user selection criteria include, e.g., a no smoking room requirement, a preference for king-size beds, and a preference for lower-floor rooms. These saved selection/preference criteria 615 may be saved on the user's computer 610 or on the opportunity database server 620, discussed below.

After the reservation inquiry has been completed, the inquiry is sent to a reservations database 625 (step 105) residing on a reservations database server 630. An exemplary reservations database is the Sabre database hosting reservations data for hotels, automobiles, and airline travel. Other reservations databases suitable for use with the invention are Galileo, Amadeus, Worldspan, Apollo, and Abacus.

The reservations database is desirably a relational database that holds product information, e.g., hotel room data, in a data management architecture that allows comparison of a product desired against products available across all product parameters (price, dates, service, product specifications, restrictions, special terms, etc.). The use of the invention is not, however, restricted to relational databases or pure relational databases. For example, Sabre is not a relational database.

The reservations database is made available to the user through conventional database connectivity technology over the internet (ODBC, XML, SOAP, etc.), over a dedicated network, or over other networks.

The reservations database finds a suitable reservation response to the inquiry. The reservation response may be: 1) a match to the inquiry, 2) a match to the inquiry with suggested alternatives, 3) no match to the inquiry and suggested alternatives, and 4) no match, no suggested alternatives (step 110).

The reservation response to the inquiry is sent from the reservations database to the user (step 110).

Upon receipt of the reservation response at the user's computer, the reservation response 635 is displayed (step 115).

The user considers reservation alternatives offered by the reservation response and makes an original purchase choice, i.e., purchase decision concerning a particular original reservation choice. Once the user has made a purchase decision, a tender of a purchase commitment for a particular original reservation is made. This tender of a purchase commitment may, e.g., be made by selecting a “buy” option or similar button on the user's computer (step 115).

After making the purchase commitment tender, the purchase script 640, located on the user's computer 610, instead of sending the tender to the reservation database 625 as per the prior art, notifies the opportunity database server 620 of the user's tender.

The user's computer generates an opportunity query and sends the opportunity query to the opportunity database server (step 115). The opportunity query includes data sufficient to find an at least equivalent substitute item from within an opportunity database 645. The opportunity query may include data provided to the reservations database concerning the user's selection criteria and data such as the nature of the response from the reservations database including reservations offered to the user. Further, the opportunity query may include data identifying the particular original reservation for which the purchase tender was made.

The opportunity database 645, hosted on the opportunity database server 620, holds reservations data for, e.g., hotels, automobiles, and airline travel. The reservations data within the opportunity database 645 includes a listing of alternative product opportunities, e.g., inventory, pricing, product characteristics.

Also hosted on the opportunity database server 620 is a transaction log 650 of transactions relayed from the user, alternative product opportunities identified for each transaction with the user, and the user's responses to opportunity offerings. The transaction log 650 advantageously enables drill-down analysis and reporting of inventory consumption, consumer (user) behavior, product relevance, supplier marketshare, and purchasing trends. Alternatively, or additionally, a transaction log may also be located on the user's computer.

The transaction log may be used in drill-down analysis.

The opportunity database 645 is desirably a relational database that holds product information, e.g., hotel room data, in a data management architecture that allows an opportunity database querying script 655 to execute a comparison of a product desired against products available across all product parameters (price, dates, service, product specifications, restrictions, special terms, etc.). The opportunity database is, however, not restricted to relational databases.

The opportunity database is made available to the user through conventional database connectivity technology over the internet (IP, ODBC, XML, SOAP, etc.), over a dedicated network, or over other networks.

The opportunity database determines a suitable opportunity response to the opportunity database query (step 120). That is, the opportunity database querying script 655 acts against the opportunity database 645 to determine if there is an at least equivalent substitute reservation that can be offered as an alternative reservation (a substitute reservation offer) for the original reservation (the original purchase choice).

At this point, the opportunity database querying script 655 has determined if there is an equivalent substitute reservation that would be suitable for presenting to the user in an effort to move the user off the original reservation choice onto a substitute reservation purchase.

If there is such an equivalent substitute reservation, the opportunity database server sends the equivalent substitute reservation to the user's computer as an alternative reservation offer (step 120). There may be plural equivalent substitute reservations that are sent as alternative reservation offers.

The alternative reservation offer is displayed on the user's computer so that the user can make a decision as to accepting the alternative reservation offer (step 125). The alternative reservation offer can be provided to the user in alternative forms, e.g., a pop-up window, an e-mail, and in printed form. The user may then accept or decline the alternative reservation offer. Information concerning the user's accepting or declining the alternative reservation offer may be included in the transaction log 650.

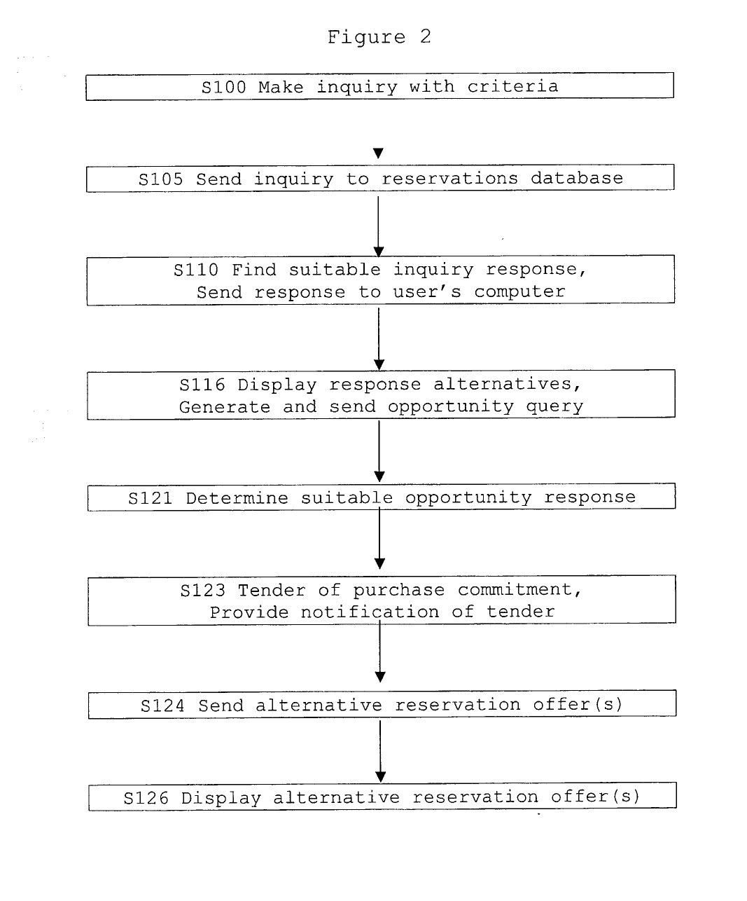

Another embodiment method of the invention is also directed to a method for making hotel rental reservations and is illustrated by FIG. 2. In the interest of conciseness, certain similar aspects between embodiments are not repeated below.

With reference to FIG. 2, a user makes the reservation inquiry (step 100).

After the reservation inquiry has been completed, the inquiry is sent to the reservations database 625 (step 105) residing on a reservations database server 630.

The reservations database finds a suitable reservation response to the inquiry. The reservation response is sent from the reservations database to the user's computer 610 (step 110).

Upon receipt of the reservation response at the user's computer, the reservation response is displayed (step 116). Also, during this step, upon receipt of the reservation response, the user's computer generates an opportunity query and sends the opportunity query to the opportunity database server 620 for action against the opportunity database 645.

The opportunity query includes data sufficient to find an at least equivalent substitute item from within the opportunity database. The opportunity query may include data provided to the reservations database concerning the user's selection criteria and data such as the nature of the response from the reservations database including reservations, if any, offered to the user.

The opportunity database determines a suitable opportunity response to the opportunity database query (step 121). That is, the opportunity database querying script 655 acts against the opportunity database 645 to determine if there is an at least equivalent substitute reservation that can be offered as an alternative reservation for the original reservation(s) being offered.

Note that the opportunity response may be determined with or without knowledge of the reservation response made by the reservations database. If the reservation response is known to the opportunity database (i.e., that data was included in the opportunity database query), the reservations response data may be included in determining a suitable opportunity response.

At this point, the opportunity database querying script 655 has determined if there is an alternative reservation that would be suitable for presenting to the user to so as to move the user off the original reservation(s) being offered by reservation response onto a substitute purchase.

At this point, the alternative reservation offer(s) may be sent to the user's computer (step 121). The exact point of sending the alternative reservation offer(s) can vary.

The user considers the original reservation offer(s) presented by the reservation database through the reservation response. Once the user has made a purchase decision, a tender of a purchase commitment for a particular original reservation is made. This tender of a purchase commitment may, e.g., be made by selecting a “buy” option or button (step 123).

If the alternative reservation offer has not yet been received from the opportunity database server, a purchase script 640, located on the user's computer, instead of sending the tender to the reservation database, notifies the opportunity database server of the user's tender.

Upon being notified of the user's tendering of a purchase commitment for the original reservation, the opportunity database server sends the alternative reservation to the user's computer as an alternative purchase offer (step 124).

The alternative reservation offer is then displayed on the user's computer and the user makes a decision as to accepting the alternative reservation offer (step 126).

If the alternative reservation offer(s) has been received by the user's computer prior to the tendering, the tender of the purchase commitment triggers a notification to the user's computer to display the alternative reservation offer (step 126).

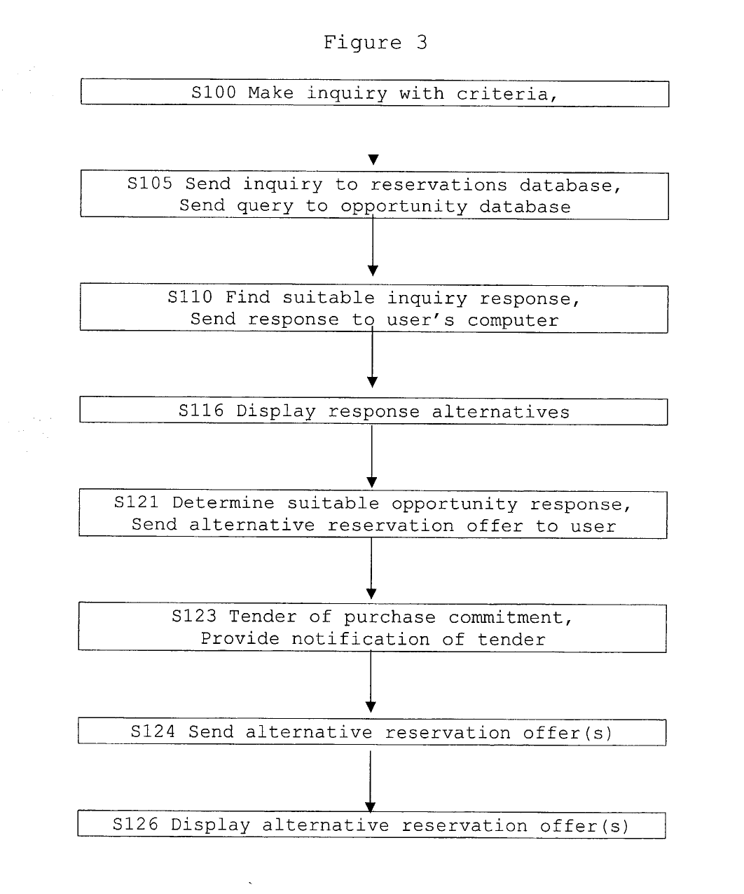

Yet another embodiment method of the invention is also directed to a method for making hotel rental reservations and is illustrated by FIG. 3. With reference to FIG. 3, a user makes the reservation inquiry (step 100).

After the reservation inquiry has been completed, the inquiry is sent to the reservations database (step 105) residing on a reservations database server.

The user's computer also generates an opportunity query and sends the opportunity query to the opportunity database server (step 105). In this embodiment, the opportunity query is made prior to the user's computer receiving the reservation response from the reservations database.

In this embodiment, the user's computer may still send data to the opportunity database server concerning the reservation response upon receipt of that reservation response, subsequent of step 110.

The opportunity database determines a suitable opportunity response to the opportunity database query (step 121). That is, the opportunity database querying script acts against the opportunity database to determine if there is an at least equivalent substitute reservation that can be offered as an alternative reservation based on the inquiry response and any data sent to the opportunity database server concerning the reservation response.

Note, however, that the opportunity response may be determined with or without knowledge of the reservation response made by the reservations database. If the reservation response is known to the opportunity database (i.e., that data was included in the opportunity database query or sent later), the reservations response data may be included in determining a suitable opportunity response.

At this point the opportunity database querying script has determined if there is an alternative reservation that would be suitable for presenting to the user and the alternative reservation offer(s) may be sent to the user's computer (step 121). The exact point of sending the alternative reservation offer(s) can vary, as can when the opportunity query is made against the opportunity database.

As in the other embodiments, the reservations database finds a suitable reservation response to the inquiry. The reservation response is sent from the reservations database to the user's computer (step 110).

Upon receipt of the reservation response at the user's computer, the reservation response is displayed showing reservation alternative (step 116).

The user considers the original reservation offer(s) presented by the reservation database through the reservation response. Once the user has made a purchase decision, a tender of a purchase commitment for a particular original reservation is made. This tender of a purchase commitment may, e.g., be made by selecting a “buy” option or button (step 123).

If the alternative reservation offer has not yet been received from the opportunity database server, a purchase script, located on the user's computer, notifies the opportunity database server of the user's tender.

Upon being notified of the user's tendering of a purchase commitment for the original reservation, the opportunity database server sends the alternative reservation to the user's computer as an alternative purchase offer (step 124).

The alternative reservation offer is then displayed on the user's computer and the user makes a decision as to accepting the alternative reservation offer (step 126).

If the alternative reservation offer(s) has been received by the user's computer prior to the tendering, the tender of the purchase commitment triggers a notification to display the alternative reservation offer (step 126).

If the alternative reservation offer is accepted, a purchase commitment for the alternative reservation goes to the opportunity database server so that the purchase of the alternative reservation is recorded. In the event that the alternative reservation offer is not accepted, the purchase commitment goes to the reservation database server so that the purchase of the original reservation is recorded. In either case, the transaction log is updated.

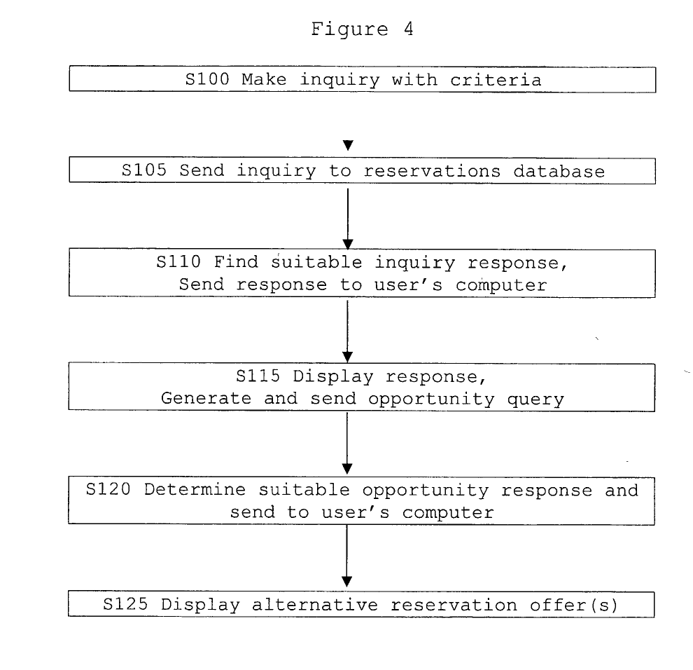

A still further method embodiment of the invention directed to a method for making hotel rental reservations is illustrated by FIG. 4.

With reference to FIG. 4, a user makes a reservation inquiry (step 100). As with other embodiments, the reservation inquiry involves providing selection/preference criteria for a desired hotel room reservation through an inquiry screen/process. The selection/preference criteria make up criteria for a characteristics set.

After the reservation inquiry has been completed, the inquiry is sent to a reservations database (step 105) residing on a reservations database server.

The reservations database finds a suitable reservation response to the inquiry. The reservation response may be: 1) a match to the inquiry, 2) a match to the inquiry with suggested alternatives, 3) no match and suggested alternatives, and 4) no match-no suggested alternatives (step 110).

The reservation response to the inquiry is sent from the reservations database to the user (step 110).

Upon receipt of the reservation response at the user's computer, the reservation response is displayed (step 115). The reservation response may, as indicated above, indicate that no suitable match was found.

Thus, the user has no reservation alternatives being offered by the reservation response and can not make an original purchase choice, i.e., purchase decision concerning a particular original reservation choice.

When a no match response is received by the user's computer, the purchase script, located on the user's computer, notifies the opportunity database server of the no match response by generating an opportunity query and sending the opportunity query to the opportunity database server (step 115).

The opportunity query includes data sufficient to find an at least equivalent substitute item from within the opportunity database. The opportunity query may include data provided to the reservations database concerning the user's selection criteria.

The opportunity database determines a suitable opportunity response to the opportunity database query (step 120). That is, the opportunity database querying script acts against the opportunity database to determine if there is an at least equivalent substitute reservation that can be offered as an alternative reservation (a substitute reservation offer) for the original reservation inquiry.

If there is such an equivalent substitute reservation, the opportunity database server sends the equivalent substitute reservation to the user's computer as an alternative reservation offer (step 120). There may be plural equivalent substitute reservations that are sent as alternative reservation offers.

The alternative reservation is displayed (step 125) for the user to consider.

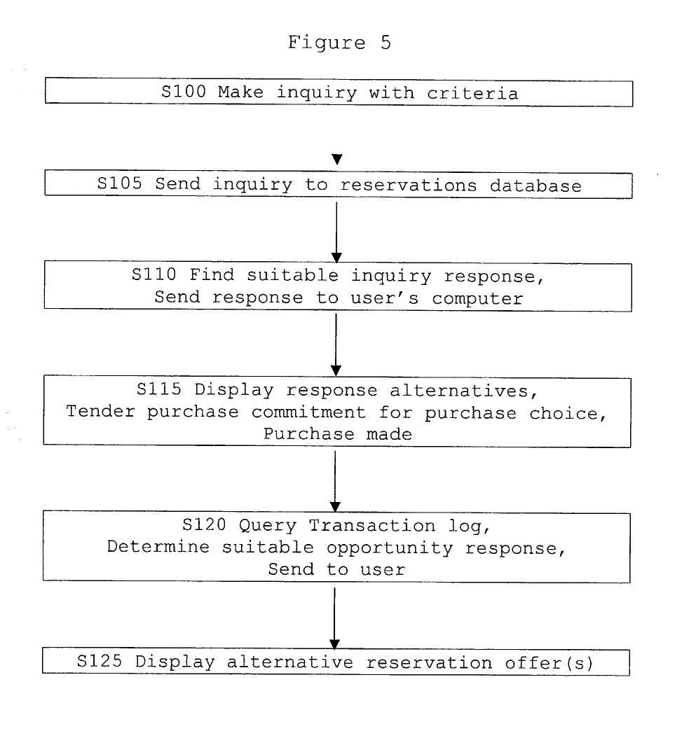

Again another method embodiment of the invention directed to a method for making hotel rental reservations is illustrated by FIG. 5. This method can be used in combination with those of FIGS. 1-4. Further, the methods of FIGS. 1-4 can be used in combination.

With reference to FIG. 5, a user makes a reservation inquiry (step 100).

After the reservation inquiry has been completed, the inquiry is sent to a reservations database (step 105) residing on a reservations database server.

The reservations database finds a suitable reservation response to the inquiry (step 110).

The reservation response to the inquiry is sent from the reservations database to the user (step 110).

Upon receipt of the reservation response at the user's computer, the reservation response is displayed (step 115).

The user considers the reservation alternatives offered by the reservation response and makes an original purchase choice, i.e., purchase decision concerning a particular original reservation choice. Once the user has made a purchase decision, a tender of a purchase commitment for a particular original reservation is made. This tender of a purchase commitment may, e.g., be made by selecting a “buy” option or similar button on the user's computer (step 115).

After making the purchase commitment tender, the purchase script, located on the user's computer, sends the tender to the reservation database and the purchase is recorded. The purchase script also notifies the transaction log 650 of the purchase.

At some time after the purchase, the transaction log is queried by a querying server 660 and a querying source 665 generates an opportunity query and sends the opportunity query to the opportunity database server (step 120). The querying server may be a centralized office server which is in communication with plural user computers.

The opportunity query includes data sufficient to find an at least equivalent substitute item from within the opportunity database. The opportunity query may include data provided to the reservations database concerning the user's selection criteria and data such as the nature of the response from the reservations database including reservations offered to the user. Further, the opportunity query includes data identifying the particular original reservation for which the purchase was made.

The opportunity database determines a suitable opportunity response to the opportunity database query (step 120). That is, the opportunity database querying script acts against the opportunity database to determine if there is an at least equivalent substitute reservation to the reservation already made.

If there is such an equivalent substitute reservation, the opportunity database server sends the equivalent substitute reservation to the user as an alternative reservation offer (step 120).

The alternative reservation offer is displayed on the user's computer so that the user can make a decision as to accepting the alternative reservation offer (step 125). The user may then accept or decline the alternative reservation offer.

Information concerning the user's accepting or declining the alternative reservation offer may be included in the transaction log.

Advantageously, the inventive method can be performed by an actor taking the form of an individual purchaser using an Internet computer, an agent at a computer, the computer itself, the computer scripts, as well as others.

An item from the opportunity database is determined to be equivalent to the item the user has committed to purchase by comparing the characteristics sets of the two items.

The invention determines if an opportunity item qualifies as the equivalent item by determining if the opportunity item comprises a characteristics set equivalent to a corresponding characteristics set for the first item. The characteristics set for an opportunity item is equivalent to the characteristics set for the first item when every item of characteristics set for the opportunity item is equivalent to corresponding items of the characteristics set for the first item.

Thus, one way of determining equivalence is an item by item test.

The user makes a purchase inquiry for a desired item by identifying values of a characteristics set for the desired item in the initial selection/query screen. Once there is a tender of the purchase commitment for the first item at the first price presented from the industry reservations database, the first item has a characteristics set equivalent to the characteristics set for the desired item, the invention determines if an opportunity item qualifies as the equivalent item by determining if the opportunity item comprises a characteristics set equivalent to the characteristics set for the first item from the industry reservations database and accepted by the consumer. In determining if an equivalent opportunity item is available, the characteristics set for the opportunity item is equivalent to the characteristics set for the first item when each item of characteristics set for the opportunity item is at least as favorable as each corresponding item of the characteristics set for the first item.

Of course, the opportunity item may be superior to the first item in one or more characteristics. This would be an enticement for the user to move off the original selection (purchase) and onto the opportunity offer item.

In some embodiments, after making a purchase inquiry for a specific item at a first price, the inventive method finds an equivalent item to the specific item at the first price by finding an opportunity item comprising a characteristics set equivalent to a characteristics set for the specific item and a price at least as favorable as the first price. After finding the opportunity item, the method tenders a sale commitment to sell the found equivalent item, with the characteristics set for the equivalent item being equivalent to the characteristics set for the specific item when each item of characteristics set for the equivalent item is at least as favorable as each corresponding item of the characteristics set for the desired item.

When the purchase inquiry is a reservation inquiry made against a first reservation computer database, the method finds the equivalent item by an inquiry made against an opportunity reservation computer database. Where the specific item is a hotel room rental, the characteristics sets of the specific item and the equivalent item may each comprise data for a hotel name field, a hotel city field, and a hotel quality indication field, and the characteristics set for the equivalent item is equivalent to the characteristics set for the specific item when a location of a hotel city field data for the equivalent item is within 10 miles of a location of a hotel city field data for the specific item and a hotel quality indication field data for the equivalent item is at least as high as a hotel quality indication field data for the specific item. Other distances and parameters may be used, e.g., 5 miles or same zip code or airport area.

Where the specific item is an automobile rental, the characteristics sets of the specific item and the equivalent item each may comprise data for an automobile model field, an automobile pickup location, and an automobile type indication field, and the characteristics set for the equivalent item is equivalent to the characteristics set for the specific item when a location of an automobile pickup location field data for the equivalent item is within 10 miles of a location of an automobile pickup location field data for the specific item and an automobile type indication field data for the equivalent item is at least as high as an automobile type indication field data for the specific item.

Where the specific item is a airline flight ticket, the characteristics sets of the specific item and the equivalent item may each comprise data for an airline name field, a flight path field, and a seat type field, and the characteristics set for the equivalent item is equivalent to the characteristics set for the specific item when a flight path field data for the equivalent item is the same as a flight path field data for the specific item and a seat type field data for the equivalent item is at least as high as a seat type field data for the specific item.

The equivalent/substitute item may be the same exact item as the first item, the substitute offer may be desirable due to price, faster delivery, an other desirable features such as a car dealer offering free maintenance.

What is claimed:

1. A method for maximizing opportunity sales by moving a purchaser off an original purchase choice and onto a substitute purchase, the method comprising the steps of:
being notified of a first actor tendering a purchase commitment for a first item at a first price; and
tendering a sale commitment to sell to the first actor an equivalent item to the first item at a price at least as favorable as the first price,
the sale commitment being presented in a form readable to the first actor.

2. The method of claim 1, wherein the tendering step comprises the further steps of:
determining if an opportunity item qualifies as the equivalent item by determining if the opportunity item comprises a characteristics set equivalent to a corresponding characteristics set for the first item; and
determining if a price of the opportunity item is at least as favorable as the first price.

3. The method of claim 2, wherein the characteristics set for an opportunity item is equivalent to the characteristics set for the first item when every item of characteristics set for the opportunity item is equivalent to corresponding items of the characteristics set for the first item.

4. The method of claim 1, comprising the further step of:
making a purchase inquiry for a desired item by identifying values of a characteristics set for the desired item;
the first actor tendering the purchase commitment for the first item at the first price,
the first item having a characteristics set equivalent to the characteristics set for the desired item;
determining if an opportunity item qualifies as the equivalent item by determining if the opportunity item comprises a characteristics set equivalent to the characteristics set for the first item;
determining if the price of the opportunity item is at least as favorable as the first price;
wherein the characteristics set for the opportunity item is equivalent to the characteristics set for the first item when each item of characteristics set for the opportunity item is at least as favorable as each corresponding item of the characteristics set for the first item.

5. The method of claim 4, wherein the tendering step is executed more than 24 hours after the step of the first actor tendering the purchase commitment for the first item at the first price.

6. A method for maximizing opportunity sales by moving a purchaser off an original purchase choice and onto a substitute purchase, the method comprising the steps of:
making a purchase inquiry for a specific item at a first price;
finding an equivalent item to the specific item at the first price by finding an opportunity item comprising a characteristics set equivalent to a characteristics set for the specific item and a price at least as favorable as the first price; and
tendering a sale commitment to sell the found equivalent item,
wherein the characteristics set for the equivalent item is equivalent to the characteristics set for the specific item when each item of characteristics set for the equivalent item is at least as favorable as each corresponding item of the characteristics set for the desired item, and
the sale commitment is in a form readable.

7. The method of claim 6, wherein,
the purchase inquiry is a reservation inquiry made against a first reservation computer database; and
the finding step comprises finding the equivalent item by an inquiry made against an opportunity reservation computer database.

8. The method of claim 7, wherein,
the specific item is a hotel room rental; and
the characteristics sets of the specific item and the equivalent item each comprise data for a hotel name field, a hotel city field, and a hotel quality indication field,
wherein the characteristics set for the equivalent item is equivalent to the characteristics set for the specific item when a location of a hotel city field data for the equivalent item is within 10 miles of a location of a hotel city field data for the specific item and a hotel quality indication field data for the equivalent item is at least as high as a hotel quality indication field data for the specific item.

9. The method of claim 7, wherein,
the specific item is an automobile rental; and
the characteristics sets of the specific item and the equivalent item each comprise data for an automobile model field, an automobile pickup location, and an automobile type indication field,
wherein the characteristics set for the equivalent item is equivalent to the characteristics set for the specific item when a location of an automobile pickup location field data for the equivalent item is within 10 miles of a location of an automobile pickup location field data for the specific item and an automobile type indication field data for the equivalent item is at least as high as an automobile type indication field data for the specific item.

10. The method of claim 7, wherein,
the specific item is a airline flight ticket; and
the characteristics sets of the specific item and the equivalent item each comprise data for an airline name field, a flight path field, and a seat type field,
wherein the characteristics set for the equivalent item is equivalent to the characteristics set for the specific item when a flight path field data for the equivalent item is the same as a flight path field data for the specific item and a seat type field data for the equivalent item is at least as high as a seat type field data for the specific item.

11. A method of making a sales offer, comprising the steps of:
making a hotel reservation inquiry from a user computer;
sending the inquiry to a hotel reservations database;
finding a suitable reservation response to the inquiry;
sending the reservation response to the inquiry from the reservations database to the user computer;
upon receipt of the reservation response at the user computer, displaying the reservation response on the user computer;
making an original purchase choice for a particular original reservation from the reservation response displayed on the user computer and making a tender of a purchase commitment for the particular original reservation;
sending the tender a transaction log to create a record of the purchase of the original reservation;
at some time after the purchase is recorded in the transaction log, querying the transaction log to read the record of the original reservation purchase;
generating an opportunity query and sending the opportunity query to the opportunity database server,
the opportunity query including data from the record sufficient to find an at least equivalent substitute item from within the opportunity database;
determining a suitable opportunity response to the opportunity database query by finding an at least equivalent substitute reservation to the original reservation purchase; and
sending the equivalent substitute reservation to the user computer as an alternative reservation offer,
the alternative reservation offer being displayed on the user computer so that the user can make a decision as to accepting the alternative reservation offer.

12. A system for maximizing opportunity sales by moving a purchaser off an original purchase choice and onto a substitute purchase, the method comprising the steps of, comprising:
a first computer program for use on a first computer serving as a user computer,
the first computer program being adapted for making a reservation inquiry for a specific item and tendering a reservation commitment for the specific item at a first price;
a second computer program for use on a second computer serving as a reservation supply computer and hosting a reservation supply database,
the second computer program being adapted for querying the reservation supply database to find an equivalent item to the specific item at the first price by finding a reservation opportunity item within the reservation supply database comprising a characteristics set equivalent to a characteristics set for the specific item and a price at least as favorable as the first price; and
the second computer program also being adapted to send a sale offer, to the first computer program, to sell the found equivalent item,
wherein the characteristics set for the equivalent item is equivalent to the characteristics set for the specific item when each item of characteristics set for the equivalent item is at least as favorable as each corresponding item of the characteristics set for the specific item.

13. The system of claim 12, wherein,
the first computer program is also adapted for
sending the reservation inquiry to a third computer program residing on a third computer serving as a master reservation computer and hosting a master reservation database,
receiving from the third computer a offering response to the reservation inquiry presenting a reservation offering for the specific item at the first price,
sending the second computer program data from the offering response, and
sending the second computer a reservation commitment sent responsive to the offering response and committing to the reservation offering; and
the second computer program is adapted for
receiving the data from the offering response,
upon receiving the reservation commitment, finding the equivalent item to the specific item at the first price within the reservation supply database, and
sending a sale commitment, to the first computer program, to sell the found equivalent item.
